(19) United States
(12) Patent Application Publication
(10) Pub. No.: US 2021/0387481 A1
(43) Pub. Date: Dec. 16, 2021

(54) STRUCTURE AND METHOD FOR MARKING TIRES

(71) Applicant: Bridgestone Americas Tire Operations, LLC, Nashville, TN (US)

(72) Inventors: Martin A. Yurjevich, North Canton, OH (US); Robert W. Asper, Wadsworth, OH (US); Keith A. Dumigan, Kent, OH (US)

(21) Appl. No.: 17/279,393

(22) PCT Filed: Oct. 9, 2019
(86) PCT No.: PCT/US2019/055331

§ 371 Date: Mar. 24, 2021

Related U.S. Application Data
(60) Provisional application No. 62/746,024, filed on Oct. 16, 2018.

(51) Int. Cl. B60C 13/00; B29D 30/72; B60C 11/01; B60C 7/10

(52) U.S. Cl. CPC B60C 13/001; B60C 7/10; B60C 11/01; B29D 30/72

(57) ABSTRACT

A non-pneumatic or pneumatic tire includes an area for tire indicia or markings. The tire includes a hub region and a tread layer. The tread layer of the tire has a shoulder with a cut out extending either partially or entirely around the shoulder of the tire tread layer. The angle of the notched or beveled portion is 45-135° with respect to an axial direction along the tread layer shoulder, and at least one indicia disposed on the at least one flat surface. The placement of the markings may be radially along the surface of the cut out portion or axially along the surface of the cut out portion. The markings may be recessed, stamped, molded, painted or applied with ink to the cut out portion. Alternatively, the indicia or marking may be applied to a decal and applied to the cut out portion.

### FIELD OF INVENTION

The present disclosure is directed to a method and tire structure for tire markings. More particularly to a recessed area on a tire with space for tire markings.

### BACKGROUND

Present pneumatic tires may have markings such as brands, tire specifications, etc. on a sidewall or shoulder region of the tire. The sidewall and shoulder regions of non-pneumatic tires, however, do not have sufficient area for tire markings. Additionally, pneumatic and non-pneumatic tires may have markings at the edge of the tread and sidewall. Placing the markings at the edge of the tread and sidewall, however, subjects the markings to wear and tear and does not make the markings particularly visible from the side view.

### SUMMARY OF THE INVENTION

In one embodiment, a non-pneumatic tire is disclosed. The non-pneumatic tire comprises a hub region having an axis of rotation, a support structure including an inner circumferential ring and an outer circumferential ring, and a tread layer extending circumferentially around the outer circumferential ring of the support structure. The tread layer has a shoulder with a cut out extending circumferentially around the entire tread layer wherein the cut out has at least one flat surface along the tread layer shoulder, and wherein the at least one flat surface is disposed at an angle of 45-135° with respect to an axial direction, and at least one indicia disposed on the at least one flat surface.

In another embodiment, a method for making a tire with areas for indicia markings shielded from abrasions is disclosed. The method comprises forming a tire, with a hub region and a support structure including an inner circumferential ring and an outer circumferential ring, providing a tread layer with a shoulder about the outer circumferential ring of the support structure forming a cut out extending circumferentially around the entire tread layer shoulder, wherein the cut out has at least one flat surface and is in the range of 45° to 135° with respect to an axial direction, providing indicia along the at least one flat surface, and curing the tire.

In yet another embodiment, a tire includes a hub region having an axis of rotation, an inner ring, and an outer ring. A support structure extends from the inner ring to the outer ring. The tire further includes a tread layer extending circumferentially around the outer ring, the tread layer extending over the width of the support structure. A flat surface is connected to the support structure and perpendicular to the tread layer. The tire also includes an applique affixed to the flat surface.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates a partial perspective view of a prior art pneumatic tire utilizing conventional placement of indicia or tire markings;

FIG. 2A illustrates a perspective view of one embodiment of a non-pneumatic tire 200 with a cut out portion for indicia or tire markings along the shoulder of the tire;

FIG. 2B illustrates a partial cross-sectional view of the non-pneumatic tire 200 showing the cut out portion for indicia or tire markings along the shoulder of the tire;

FIG. 3A illustrates a perspective view of one embodiment of a non-pneumatic tire 300 with a beveled edge for indicia or tire markings along the entire shoulder of the tire;

FIG. 3B illustrates a partial cross-sectional view of the non-pneumatic tire 300;

FIG. 4 illustrates a partial perspective view of an alternative embodiment of a non-pneumatic tire with a beveled edge portion for indicia or tire markings along part of the shoulder of the tire;

FIG. 5 illustrates a flowchart for making a tire with a cut out portion for indicia or markings;

FIG. 6 illustrates a partial perspective view of another alternative embodiment of a non-pneumatic tire with a flat surface for indicia or tire markings along a support structure;

FIG. 7 illustrates a partial perspective view of one embodiment of a non-pneumatic tire and hub assembly with a flat surface for indicia or tire markings along the hub; and

FIG. 8 illustrates a perspective view of an alternative embodiment of a non-pneumatic tire and hub assembly with a flat surface for indicia or tire markings along the hub.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions. Where the definitions include a reference to a tire, it should be understood to also reference a tire mold.

“Axial” or “axially” refer to a direction that is parallel to the axis of rotation of a tire.

“Bead” refers to the part of the tire that contacts the wheel and defines a boundary of the sidewall.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” refers to that portion of the tire between the tread and the bead.

“Tread” refers to that portion of the tire that comes into contact with the road under normal inflation and load.

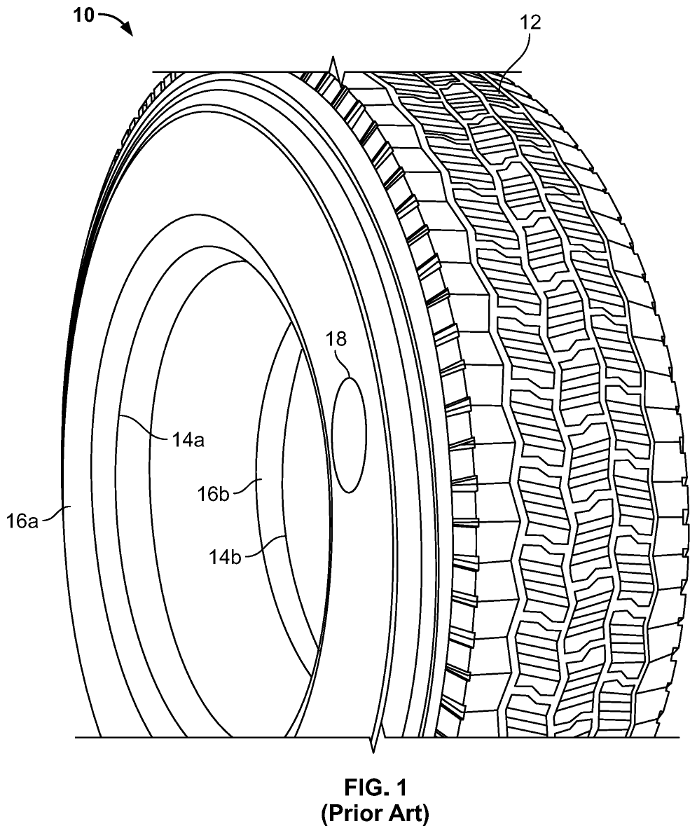

FIG. 1 illustrates a perspective view of a pneumatic tire 10 utilizing current conventional sidewall markings. The pneumatic tire 10 has a circumferential tread 12 and a pair of bead regions 14, including a first bead region 14a and a second bead region 14b. A first sidewall 16a extends from the first bead 14a to the circumferential tread 12 and a second sidewall (not shown in this view) extends from the second bead 14b to the circumferential tread 12. The first sidewall 16a includes an area for tire markings or indicia 18. However, markings or indicia in this region of the tire are exposed to damage from objects such as curbs. Additionally, non-pneumatic tires may not have the same available sidewall space for placing markings or indicia.

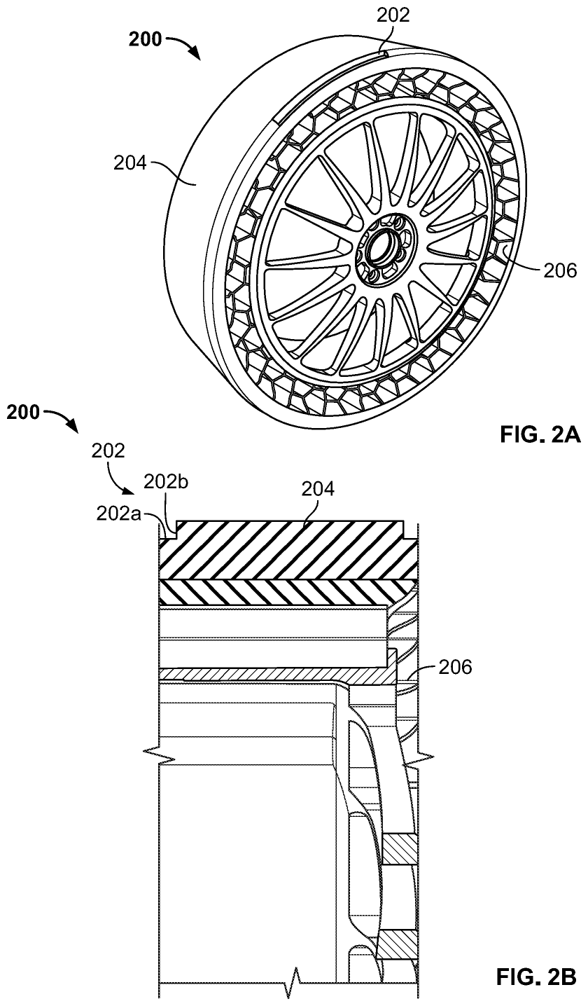

FIG. 2A illustrates a perspective view of one embodiment of a non-pneumatic tire 200 with a cut out portion 202 for tire markings or indicia on the tire. The cut out portion 202 defines a location that is out of the wear area of the tread 204 of the non-pneumatic tire 200, and that is protected from curb (or other obstacle) abrasion. In the illustrated embodiment, the cut out portion 202 is localized around the markings only. While a single cut out portion 202 is shown on each side of the tire, it should be understood that multiple cut out portions may be employed. In an alternative embodiment, the cut out portion may extend beyond the markings of the tire. For example, the cut out portion may be circumferential and continuous around the entire tire.

The non-pneumatic tire 200 also includes a support structure 206 that may be webbing or a spoke construction.

FIG. 2B illustrates a close up cross-sectional view of the non-pneumatic tire 200, and shows the cut out portion 202. In the illustrated embodiment, the cut out portion 202 has a laterally extending surface 202a and a radially extending surface 202b, forming a right angle. In one embodiment, the markings are disposed on the laterally extending surface 202a. In an alternative embodiment, the markings are disposed on the radially extending surface 202b.

In alternative embodiments, the surfaces forming the cut out portion define an angle in the range of 45-135°. In such embodiments, the angle of the lateral surface with respect to the radial direction may be between −45 and +45, and the angle of the radial surface with respect to the radial direction may be between −45 and +45. In other embodiments, the cutout portion may be defined by an angle outside these ranges, so long as the tire stability is maintained.

In an alternative embodiment, the cut out portion could have three or more surfaces. While the cut out portion 202 is defined by straight surfaces in the illustrated embodiment, it should be understood that one or more of the surfaces may be curved.

The markings may be recessed onto the cut out portion 202. In another embodiment, the markings are stamped onto the cut out portion 202. In another embodiment, the markings may be molded onto the cut out portion 202. In another embodiment, the markings may be painted or applied with ink onto the cut out portion 202. In another embodiment, the markings may be applied to a decal, and the decal and applied to the cut out portion 202.

In an alternative embodiment (not shown), the tire can be a pneumatic tire with a circumferential tread region. In the pneumatic tire, the support structure is defined by a pair of sidewalls, and the hub region is defined by a pair of beads. In such an embodiment, a cut out portion is formed in the shoulder between the tread region and the sidewalls.

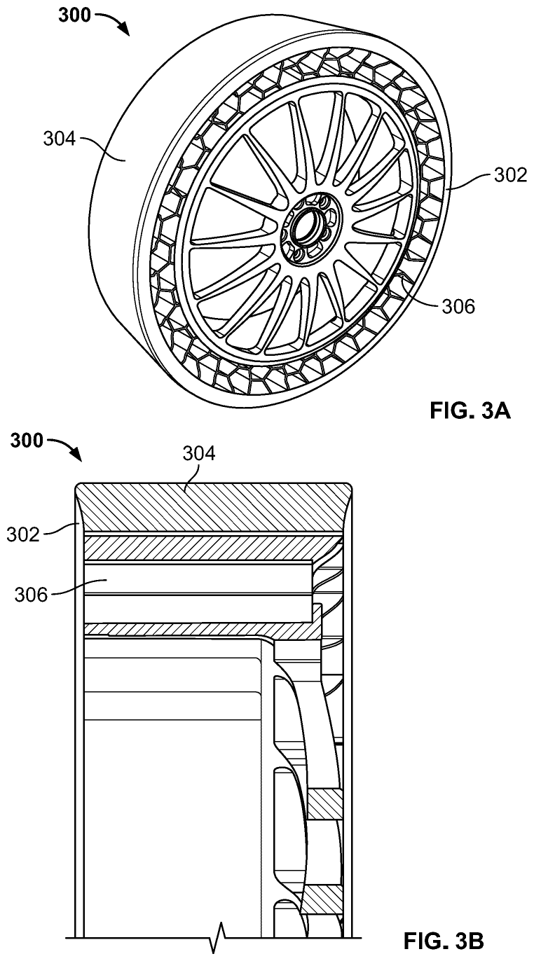

FIG. 3A illustrates a non-pneumatic tire 300 with an undercut 302 that forms a cut out portion for indicia or tire markings along the entire shoulder of the tire. The non-pneumatic tire 300 includes a tread 304 and a support structure 306 that may be webbing or a spoke construction.

In the illustrated embodiment, the undercut 302 extends from the outer surface of the tread 304 to the support structure 306. In an alternative embodiment, the undercut extends from an outer surface of the tread to an elevation radially above the support structure.

The undercut 302 has an angle in the range of 45-135° with respect to the radial direction. The markings may be placed on the surface of the undercut. In the illustrated embodiment, the undercut 302 extends continuously around the entire tire. In an alternative embodiment, the undercut only extends around a portion of the tire.

FIG. 3B illustrating a close up cross-sectional view of a non-pneumatic tire 300 showing the undercut 302 for indicia or tire markings along the entire shoulder of the tire. In the illustrated embodiment, the undercut 302 is defined by a single curved surface. In an alternative embodiment, the undercut is defined by a single straight surface. In another alternative embodiment, the undercut is defined by multiple surfaces. Each of the surfaces may be straight or curved.

As with the embodiments discussed above with reference to FIGS. 2A and 2B, in an alternative to the embodiments shown in FIGS. 3A and 3B, the tire can be a pneumatic tire with a circumferential tread region. In the pneumatic tire, the support structure is defined by a pair of sidewalls, and the hub region is defined by a pair of beads. In such an embodiment, a cut out portion is formed in the shoulder between the tread region and the sidewalls.

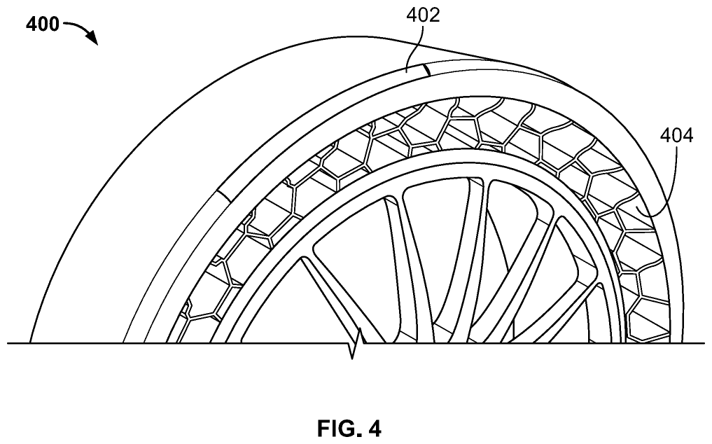

FIG. 4 illustrates a perspective view of a non-pneumatic tire 400 with a beveled edge 402 that forms a cut out portion for indicia or tire markings along part of the shoulder of the tire. The beveled edge 402 may be disposed at an angle between 10-80° with respect to the radial direction. In the illustrated embodiment, the beveled edge 402 is defined by a straight surface that extends along a portion of the circumference. In an alternative embodiment, a plurality of beveled edges may be employed on each side of the tire. In another alternative embodiment, the beveled edge may extend around the entire circumference of the tire. In yet another alternative embodiment, the beveled edge may be defined by a curved surface.

The markings may be recessed onto the beveled edge 402. In another embodiment, the markings are stamped onto the beveled edge 402. In another embodiment, the markings may be molded onto the beveled edge 402. In another embodiment, the markings may be painted or applied with ink onto the beveled edge 402. In another embodiment, the markings may be applied to a decal and applied to the beveled edge 402.

As with the other embodiments discussed above, in an alternative to the FIG. 4 embodiment, the tire can be a pneumatic tire with a circumferential tread region. In the pneumatic tire, the support structure is defined by a pair of sidewalls, and the hub region is defined by a pair of beads. In such an embodiment, a cut out portion is formed in the shoulder between the tread region and the sidewalls.

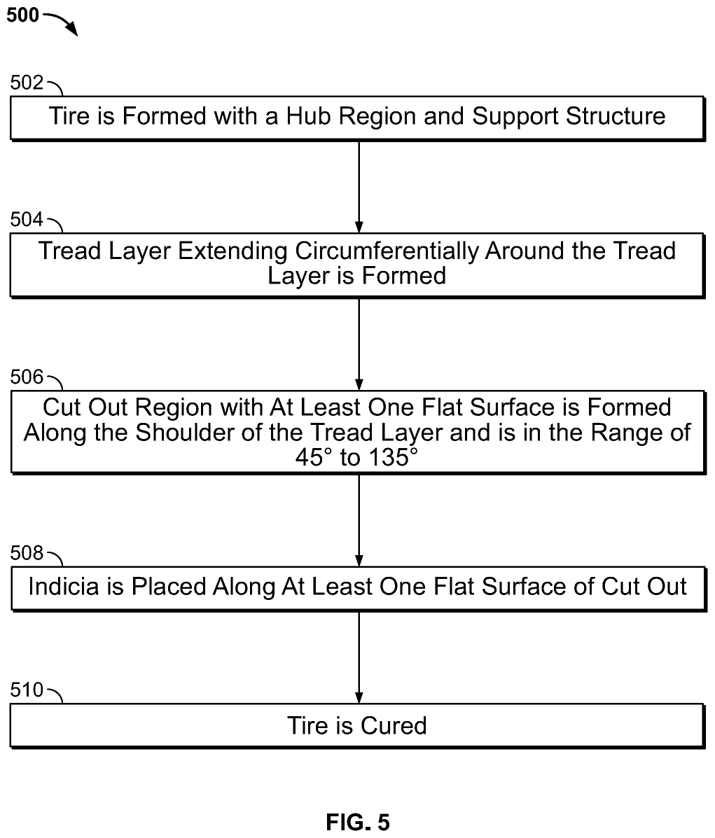

FIG. 5 shows a flowchart that illustrates an exemplary method 500 for making a tire with areas for indicia markings shielded from abrasions. At 502 the tire is formed according to known manufacturing processes. The tire may be a pneumatic or a non-pneumatic tire. A tread layer extending circumferentially around the tread layer is formed 504. The formed tire includes a circumferential tread with a cutout region on the tread shoulder layer 506 with an angle in the range of 45° to 135°. Prior to curing the tire 510, the tire markings or indicia are placed on the at least one flat surface 508. As previously described, the cut out range may be outside of the 45° to 135° range so long as the tire remains stable or the indicia may be placed below the side edge of the tread band and may or may not be connected to the tread band. In an alternative embodiment, the cut out is formed by an extrusion process, a 3D printing process, or cutting the rubber. In another embodiment, the cut out portion is formed during the tire molding process.

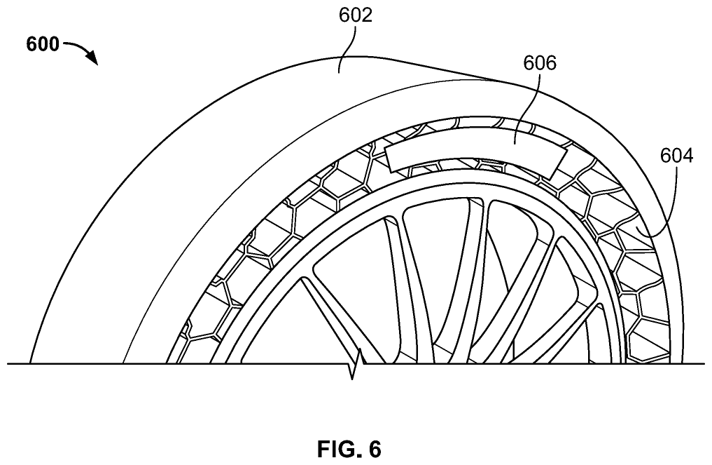

FIG. 6 illustrates a partial perspective view of another alternative embodiment of a non-pneumatic tire 600. The tire 600 includes a circumferential tread 602 is disposed about a support structure 604. In the illustrated embodiment, the support structure 604 is a webbing extending from an inner ring to an outer ring. In an alternative embodiment, the support structure may be a plurality of spokes.

A flat surface 606 for indicia or tire markings is disposed along the support structure 604. In the illustrated embodiment, a single flat surface 606 extends along a portion of the support structure 604. In an alternative embodiment, a flat surface extends circumferentially around the entire support structure. In another alternative embodiment, a plurality of flat surfaces are spaced about the support structure.

The flat surface 606 may be formed on the support structure 604 by a molding or 3D printing process. Alternatively, the flat surface 606 may be formed separately from, and then attached to the support structure 604. In such an embodiment, the flat surface 606 may be attached to the support structure 604 with adhesive, a fastener (such as bolts or screws), or other known attachment means.

In one embodiment, the flat surface 606 is constructed of the same material as the support structure 604. In an alternative embodiment, the flat surface 606 and the support structure 604 are constructed of different materials.

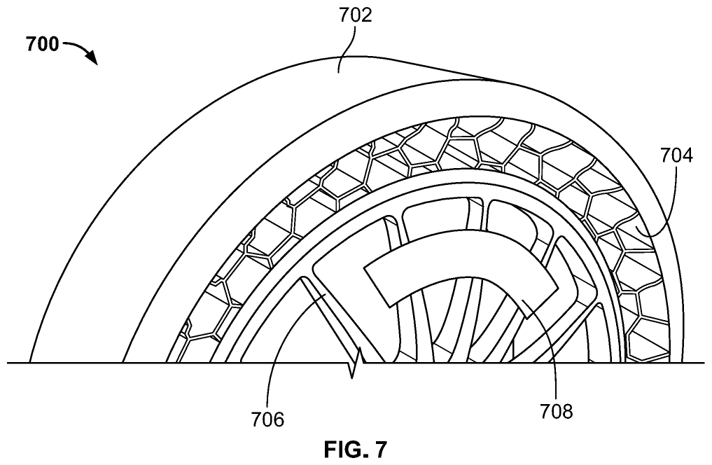

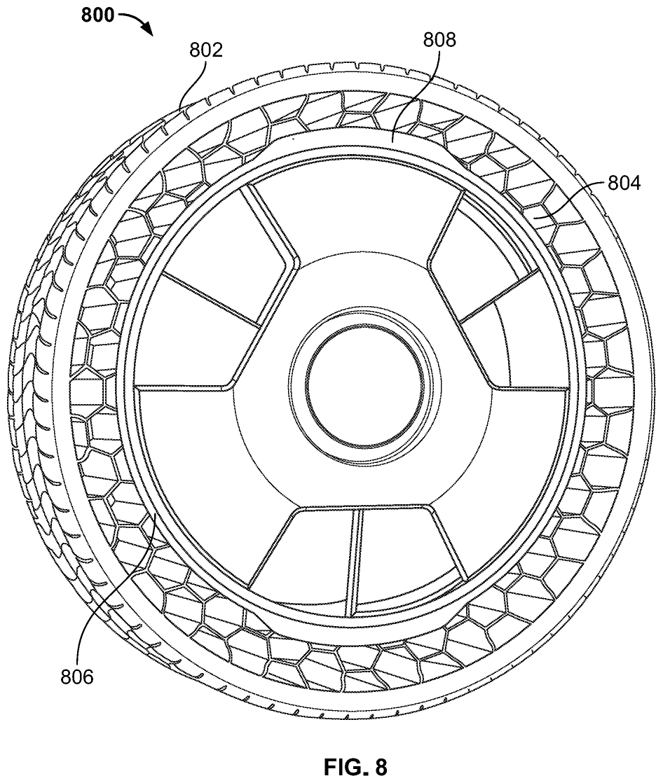

FIG. 7 illustrates a partial perspective view of one embodiment of a non-pneumatic tire and hub assembly 700. The tire and hub assembly 700 includes tire having a circumferential tread 702 disposed about a support structure 704. In the illustrated embodiment, the support structure 704 is a webbing extending from an inner ring to an outer ring. In an alternative embodiment, the support structure may be a plurality of spokes.

The hub includes a plurality of spokes 706. A flat surface 708 for indicia or tire markings is disposed along the spokes 706. In the illustrated embodiment, a single flat surface 708 extends along a portion of the spokes 706. In an alternative embodiment, a flat surface extends circumferentially around all of the spokes. In another alternative embodiment, a plurality of flat surfaces are spaced about the spokes.

The flat surface 708 may be formed on the spokes 706 by a molding or 3D printing process. Alternatively, the flat surface 708 may be formed separately from, and then attached to the spokes 706. In such an embodiment, the flat surface 708 may be attached to the spokes 706 with adhesive, a fastener (such as bolts or screws), or other known attachment means.

In one embodiment, the flat surface 708 is constructed of the same material as the spokes 706. In an alternative embodiment, the flat surface 708 and the spokes 706 are constructed of different materials.

FIG. 7 illustrates a perspective view of an alternative embodiment of a non-pneumatic tire and hub assembly 800. The tire and hub assembly 700 includes tire having a circumferential tread 802 disposed about a support structure 804. In the illustrated embodiment, the support structure 804 is a webbing extending from an inner ring to an outer ring. In an alternative embodiment, the support structure may be a plurality of spokes.

A ring 806 is disposed between the tire and the hub. In one embodiment, the ring 806 is the inner ring of the non-pneumatic tire. In an alternative embodiment, the ring 806 is an outer ring of the hub. In yet another embodiment, the ring is separate from and attached to the non-pneumatic tire and the hub.

In the illustrated embodiment, pair of flat surfaces 808 for indicia or tire markings extend from the ring 806. The flat surfaces 808 extend in a substantially radial direction. While a pair of flat surfaces 808 are shown in the illustrated embodiment, it should be understood that any number of flat surfaces may extend from the ring. For example, the flat surface may be a flange that extends circumferentially about the entire ring.

In one embodiment, the flat surface 808 is constructed of the same material as the webbing 804. In an alternative embodiment, the flat surface 808 and the webbing 804 are constructed of different materials.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative system and method, and illustrative examples shown and described. Accordingly, departures may be made from such details without departing from the spirit or scope of the applicant's general inventive concept.

What is claimed is:

1. A tire comprising:
a hub region having an axis of rotation;
a support structure extending from the hub region; and
a tread layer extending circumferentially around the support structure,
wherein the tread layer has a shoulder with a cut out portion extending circumferentially around the entire tread layer
wherein the cut out portion has at least one flat surface along the shoulder, and
wherein the at least one flat surface is disposed at an angle of 45-135° with respect to an axial direction, and
at least one indicia disposed on the at least one flat surface.

2. The tire of claim 1, wherein the support structure is a plurality of spokes.

3. The tire of claim 1, wherein the support structure is a webbing.

4. The tire of claim 1, wherein the cut out portion forms a right angle.

5. The tire of claim 1, wherein the cut out portion is a beveled edge.

6. The tire of claim 1, wherein the at least one flat surface has stamped markings.

7. The tire of claim 6, wherein the stamped markings are on a radially extending portion of the cut out portion perpendicular to the tread layer.

8. The tire of claim 1, wherein the at least one flat surface has recessed markings.

9. The tire of claim 8, wherein the recessed markings are on a radially extending portion of the cut out perpendicular to the tread layer.

10. The tire of claim 1, wherein the indicia is disposed on an applique affixed to the flat surface.

11. A method for making a tire with areas for indicia markings shielded from abrasions, the method comprising:
forming a tire, with a hub region and a support structure including an inner circumferential ring and an outer circumferential ring;
providing a tread layer with a shoulder about the outer circumferential ring of the support structure
forming a cut out extending circumferentially around the entire shoulder, wherein the cut out has at least one flat surface and is in a range of 45° to 135° with respect to an axial direction;
providing indicia along the at least one flat surface; and
curing the tire.

12. The method of claim 11, wherein the forming of the cut out includes forming the cut out by an extrusion process, a 3D printing process, or cutting the tread layer.

13. The method of claim 11, wherein the providing of the indicia includes stamping the at least one flat surface.

14. The method of claim 11, wherein the providing of the indicia includes placing a sticker with the indicia on the at least one flat surface.

15. The method of claim 11, wherein the indicia are provided on a radially extending portion of the cut out perpendicular to the tread layer.

16. A tire comprising:
a hub region having an axis of rotation;
an inner ring;
an outer ring;
a support structure extending from the inner ring to the outer ring;
a tread layer extending circumferentially around the outer ring, the tread layer extending over a width of the support structure;
a flat surface connected to the support structure and perpendicular to the tread layer; and
an applique affixed to the flat surface.

17. The tire of claim 16, wherein the flat surface extends circumferentially around an entire edge of the support structure, perpendicular to the tread layer.

18. The tire of claim 16, wherein the support structure is a plurality of spoke rings.

19. The tire of claim 16, wherein the flat surface has stamped markings.

20. The tire of claim 16, wherein the flat surface has recessed markings.
